(19) United States
(12) Patent Application Publication
(10) Pub. No.: US 2007/0245102 A1
(43) Pub. Date: Oct. 18, 2007

(54) Storage system, data management apparatus and management method thereof

(75) Inventors: Akitsugu Kanda, Sagamihara (JP); Takaki Nakamura, Ebina (JP); Yoji Nakatani, Yokohama (JP); Yohsuke Ishii, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/447,593

(22) Filed: Jun. 5, 2006

(30) Foreign Application Priority Data
Apr. 17, 2006 (JP) 2006-113559

(51) Int. Cl. G06F 12/16

(52) U.S. Cl. 711/161

(57) ABSTRACT

Provided are a storage system, a data management apparatus, and a data management method capable of facilitating the add-on procedures of data management apparatuses for managing data groups such as directory groups. In a storage system comprising a plurality of data management apparatuses for managing storage destination management information of a data group stored in a storage extent of a prescribed storage controller, at least one of the data management apparatuses decides the respective data management apparatuses to newly manage the data group for each of the data groups based on the importance of each of the data groups or the loaded condition of each of the data management apparatuses, and migrates storage destination management information containing information regarding the storage destination of the data group to the data management apparatus to newly manage the data group based on the decision as necessary.

### CROSS-REFERENCES TO RELATED APPLICATIONS

This application relates to and claims priority from Japanese Patent Application No. 2006-113559, filed on Apr. 17, 2006, the entire disclosure of which is incorporated herein by reference.

### BACKGROUND

The present invention relates to a storage system, a data management apparatus, and a data management method that can be suitably applied, for instance, in a storage system based on global namespace technology.

Conventionally, a NAS (Network Attached Storage) apparatus was used as an apparatus for realizing access to a storage apparatus at the file level.

In recent years, as one file management system utilizing this NAS apparatus, a system referred to as a global namespace has been proposed. Global namespace is technology of bundling the namespaces of a plurality of NAS apparatuses for configuring a single namespace.

With a storage system based on this kind of global namespace technology, upon adding on a NAS apparatus, a process of migrating the management of some data groups among the plurality of data groups already existing therein to the newly added NAS apparatus (this is hereinafter referred to as a “management migration process”) will be required. Conventionally, this management migration process was being performed manually by the system administrator (refer to Japanese Patent Laid-Open Publication No. 2004-30305).

### SUMMARY

Nevertheless, with the management migration process, in addition to simply migrating the management of the data group in the global namespace to the newly added NAS apparatus (this is hereinafter referred to as an “expanded NAS apparatus”), there are cases where it is necessary to reconsider the affiliated NAS apparatus of the respective data groups in consideration of load balancing and importance of data groups of the respective NAS apparatuses.

In the foregoing case, the system administrator needs to decide the affiliated NAS apparatus of the respective data groups based on the processing capacity of the CPU in the NAS apparatus, apparatus quality such as the storage capacity and storage speed of the disk apparatuses connected to the NAS apparatus, and importance of the data group, and the data and management information of a required data group must also be migrated to the newly affiliated NAS apparatus.

However, decision on the affiliated NAS apparatus of the data group and the management migration process of the affiliated NAS apparatus heavily depend upon the capability and experience of the system administrator, and there is a problem in that the affiliation of the respective data groups is not necessarily decided to be a NAS apparatus having an optimal apparatus quality according to the importance thereof. Further, since the decision on the affiliated NAS apparatus of the data group and the management migration process of the affiliated NAS apparatus were all conducted manually by the system administrator, there is a problem in that the burden on the system administrator is overwhelming.

The present invention was devised in view of the foregoing points, and an object of the present invention is to propose a storage system, a data management apparatus, and a data management method capable of facilitating the add-on procedures of data management apparatuses for managing data groups.

In order to achieve the foregoing object, the present invention provides a storage system comprising one or more storage apparatuses; and a plurality of data management apparatuses for managing a data group stored in a storage extent provided by the storage apparatuses, at least one of the data management apparatuses decides the respective data management apparatuses to newly manage the data group for each of the data groups based on the importance of each of the data groups or the loaded condition of each of the data management apparatuses, and migrates storage destination management information containing information regarding the storage destination of the data group to the data management apparatus to newly manage the data group based on the decision as necessary.

The present invention also provides a data management apparatus for storing a data group stored in a storage extent provided by a storage apparatus, comprising a decision unit for deciding the respective data management apparatuses to newly manage the data group for each of the data groups based on the importance of each of the data groups or the loaded condition of each of the data management apparatuses; and a management information migration unit for migrating storage destination management information containing information regarding the storage destination of the data ornup to the data management apparatus to newly manage the data group based on the decision as necessary.

The present invention also provides a data management method in a data management apparatus for storing a data group stored in a storage extent provided by a storage apparatus, comprising the steps of deciding the respective data management apparatuses to newly manage the data group for each of the data groups based on the importance of each of the data groups or the loaded condition of each of the data management apparatuses; and migrating storage destination management information containing information regarding the storage destination of the data group to the data management apparatus to newly manage the data group based on the decision as necessary.

According to the present invention, when adding on a data management apparatus, it is possible to facilitate the management process of data groups in the respective data management apparatuses to be performed by the system administrator. As a result, it is possible to realize a storage system, a data management apparatus, and a data management method capable of facilitating the add-on process of data management apparatuses.

### DESCRIPTION OF DRAWINGS

FIG. 1 is a block diagram showing the storage system according to an embodiment of the present invention;

FIG. 2 is a block diagram showing the configuration of the master NAS apparatus;

FIG. 3 is a block diagram showing the configuration of the slave NAS apparatus;

FIG. 4 is a block diagram showing the configuration of the storage apparatus;

FIG. 5 is a diagram showing a configuration example of the file tree structure in a global namespace;

FIG. 6A to FIG. 6D are diagrams showing the directory configuration management table in the respective directory groups;

FIG. 7A and FIG. 7B are diagrams showing the directory configuration management table in the respective directory group;

FIG. 8A and FIG. 8B are diagrams showing the quality list management table in the respective NAS apparatuses;

FIG. 9 is a diagram showing the configuration list management table in the respective directory groups;

FIG. 10 is a diagram showing the affiliated apparatus management table of the respective directory groups;

FIG. 11A to FIG. 11C are diagrams showing the disk mapping list management table of the respective directory groups;

FIG. 12 is a diagram showing the setting management table of a NAS apparatus;

FIG. 13 is a flowchart showing a directory group configuration list change routine upon adding a directory group;

FIG. 14 is a diagram showing the management information registration screen of the administrator terminal apparatus;

FIG. 15 is a flowchart showing the setting change routine of the NAS apparatus;

FIG. 16 is a flowchart showing the apparatus quality list change routine upon adding a NAS apparatus;

FIG. 17 is a diagram showing the expanded NAS registration screen of the management terminal apparatus upon adding a NAS apparatus;

FIG. 18 is a flowchart showing the configuration information migration routine upon adding a NAS apparatus; and

FIG. 19 is a flowchart showing the configuration information migration routine upon adding a NAS apparatus.

### DETAILED DESCRIPTION

An embodiment of the present invention is now explained with reference to the attached drawings.

### (1) Configuration of Storage System in this Embodiment

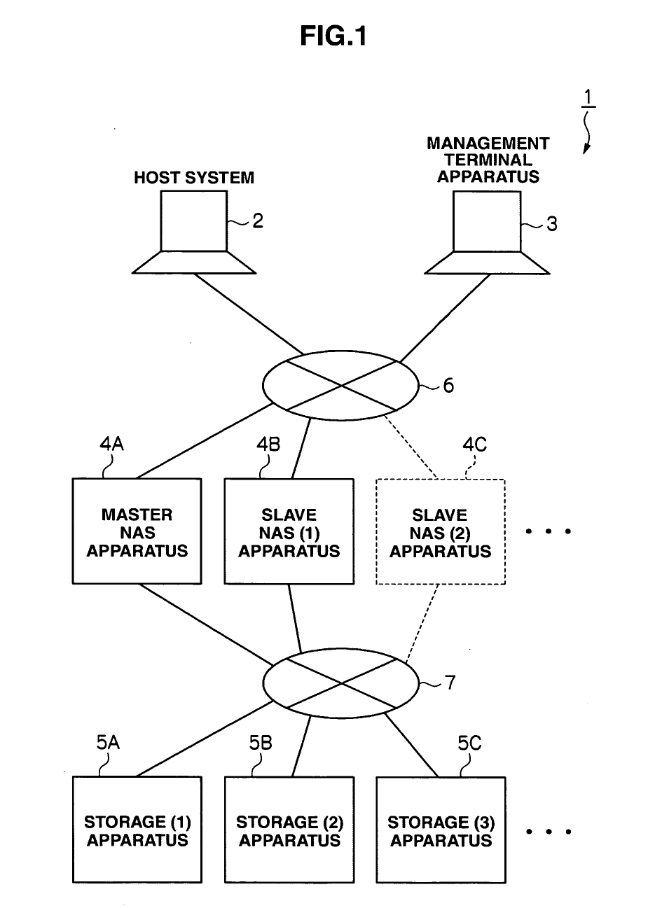

FIG. 1 shows the configuration of a storage system 1 according to this embodiment. The storage system 1 is configured by a host system 2 being connected to a plurality of NAS apparatuses 4A, 4B via a first network, and the NAS apparatuses 4 being connected to a plurality of storage apparatuses 5A, 5B . . . via a second network. Incidentally, the storage system 1 of this embodiment includes a NAS apparatus and a storage apparatus.

The host system 2 is a computer apparatus comprising information processing resources such as a CPU (Central Processing Unit) and memory, and, for instance, is configured from a personal computer, workstation, or mainframe. The host system 2 has an information input apparatus (not shown) such as a keyboard, switch, pointing apparatus or microphone, and an information output apparatus such as a monitor display or speaker.

The management terminal apparatus 3 is a server for managing and monitoring the NAS apparatuses 4A, 4B, and comprises a CPU, memory (not shown) and the like. The memory stores various control programs and application software, and various processes including the control processing for managing and monitoring the NAS apparatuses 4A to 4N are performed by the CPU executing such control programs and application software.

The first network 6, for example, is configured from an IP network of LAN or WAN, SAN, Internet, dedicated line or public line. Communication between the host system 2 and the NAS apparatuses 4A, 4B and communication between the host system 2 and the management terminal apparatus 3 via the first network 6 are conducted according to a fibre channel protocol when the first network 6 is a SAN, and conducted according to a TCP/IP (Transmission Control Protocol/Internet Protocol) protocol when the first network 6 is an IP network (LAN, WAN).

The NAS apparatuses 4A, 4B are file servers that provide a file service function to the host system 2 so as to enable access to the directory group under its control at the file level. Among the NAS apparatuses 4A, 4B, at least one of the NAS apparatuses 4A is loaded with a function for comprehensively managing all NAS apparatuses. In this embodiment, only one NAS apparatus (this is hereinafter referred to as a “master NAS apparatus”) 4A capable of comprehensively managing all NAS apparatuses is provided.

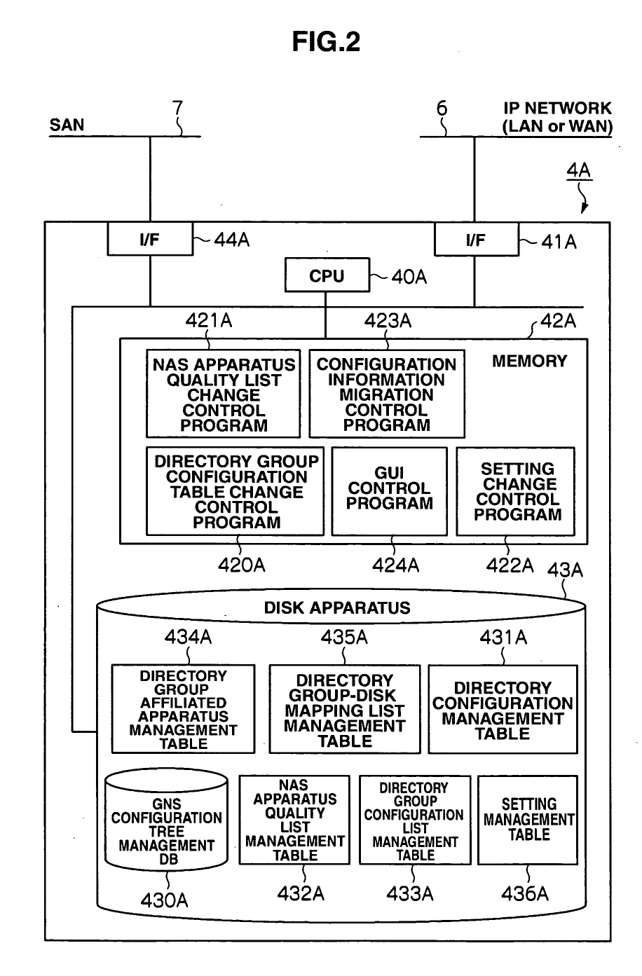

The master NAS apparatus 4A, as shown in FIG. 2, comprises network interfaces 41A, 44A, a CPU 40A, a memory 42A, and a disk apparatus 43A.

The CPU 40A is a processor for governing the control of the overall operation of the respective NAS apparatuses 4A to 4C, and performs the various control processes described later by executing the various control programs stored in the memory 42A.

The memory 42A is used for retaining various control programs and data. The various control programs described later; namely, a NAS apparatus quality list change control program 421A, a directory group configuration list change program 420A, a configuration information migration control program 423A, a setting change control program 422A, and a GUI (Graphical User Interface) control program 424A are stored in the memory 42A.

The first network interface 41A is an interface for the CPU 40A to send and receive data and various commands to and from the host system 2 and the management terminal apparatus 3 via the first network 6.

The disk apparatus 43A, for instance, is configured from a hard disk drive. The disk apparatus 43A stores a directory group affiliated apparatus management table 434A, a global namespace configuration tree management DB 430A, a NAS apparatus quality list management table 432A, a directory group-disk mapping list management table 435A, a directory group configuration list management table 433A, a directory configuration management table 431A, and a setting management table 436A. The various management tables will be described later.

The second network interface 44A is an interface for the CPU 40A to communicate with the storage apparatuses 5A, 5B via the second network 7. The second network interface 44A is configured from a fibre channel or a SAN. Communication between the NAS apparatuses 4A, 4B and the storage apparatuses 5A, 5B . . . via the second network 7 is conducted, for example, according to a fibre channel protocol.

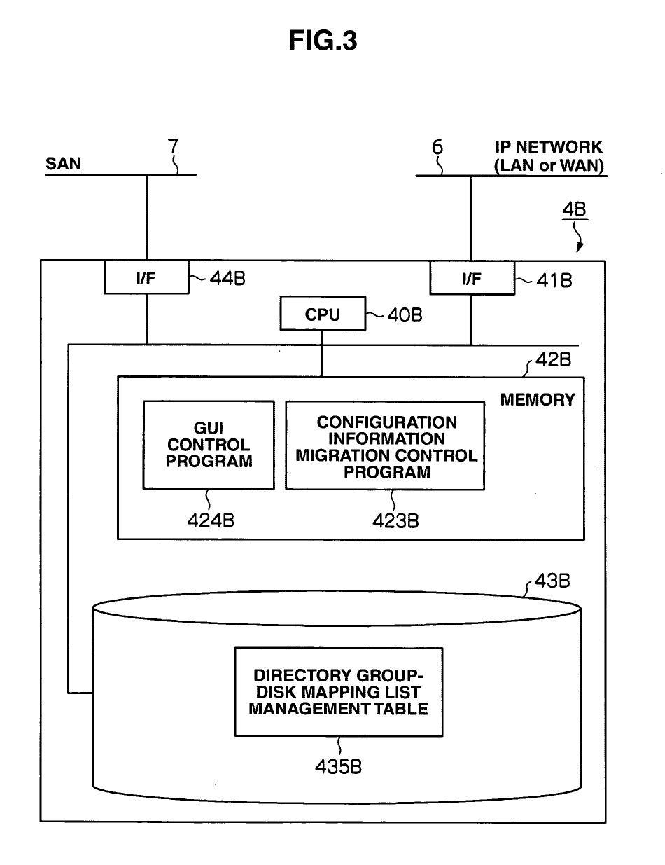

Meanwhile, the other NAS apparatuses 4B (these are hereinafter referred to as “slave NAS apparatuses”) other than the master NAS apparatus 4A, as shown in FIG. 3, comprise network interfaces 41B, 44B, a CPU 40B, a memory 42B, and a disk apparatus 43B as with the master NAS apparatus 4A. Among the above, the network interfaces 41 B, 44B and the CPU 40B have the same functions as the corresponding components of the master NAS apparatus 4A, and the explanation thereof is omitted.

The memory 42B is used for retaining various control programs and data. In the case of this embodiment, the memory 42B of the slave NAS apparatus 4B stores a configuration information migration control program 423B, and a GUI control program 424B. Further, the disk apparatus 43B is configured from a hard disk drive or the like. The disk apparatus 43B stores a directory group disk mapping list management table 435B.

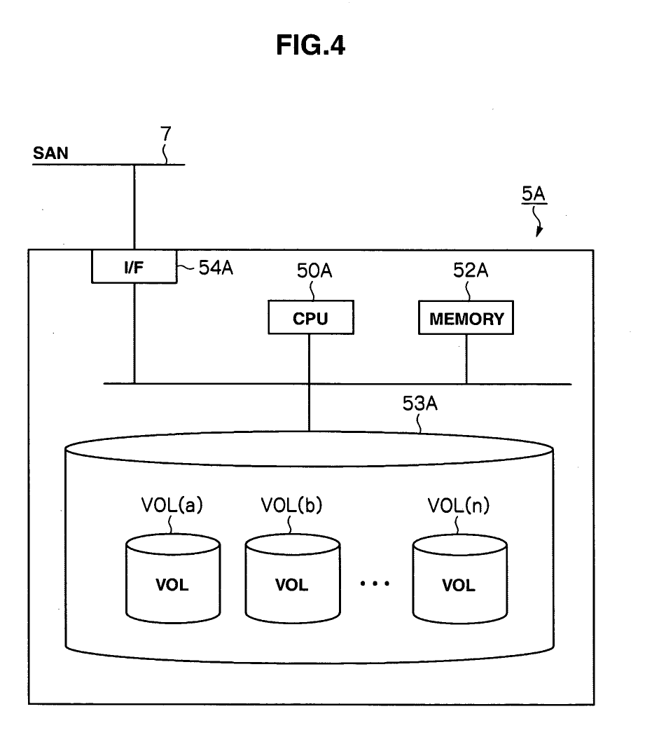

The storage apparatuses 5A, 5B . . . , as shown in FIG. 4, comprise network interfaces 54A, a CPU 50A, a memory 52A and a storage device 53A.

The network interface 54A is an interface for the CPU 50A to communicate with the master NAS apparatus 4A and the slave NAS apparatus 4B via the second network 7.

The CPU 50A is a processor for governing the control of the overall operation of the storage apparatuses, and executes various processes according to the control programs stored in the memory 52A. Further, the memory 52A, for instance, is used as the work area of the CPU 50A, and is also used for storing various control programs and various data.

The storage device 53A is configured from a plurality of disk devices (not shown). As the disk devices, for example, expensive disks such as SCSI (Small Computer System Interface) disks or inexpensive disks such as SATA (Serial AT Attachment) disks or optical disks may be used.

The respective disk devices are operated by the CPU 50A according to a RAID system. One or more logical volumes (these are hereinafter referred to as “logical volumes”) VOL (a) to (n) are configured in a physical storage extent provided by one or more disk devices. Data is stored in block (this is hereinafter referred to as “logical block”) units of a prescribed size in the logical volumes VOL (a) to (n).

A unique identifier (this is hereinafter referred to as an “LU (Logical Unit number)”) is given to the respective logical volumes VOL (a) to (n). In this embodiment, the input and output of data is conducted using the combination of the LU and a unique number (LBA: Logical Block Address) given to the respective logical blocks as the address, and designating such address.

### (2) File Tree Structure in Global Namespace

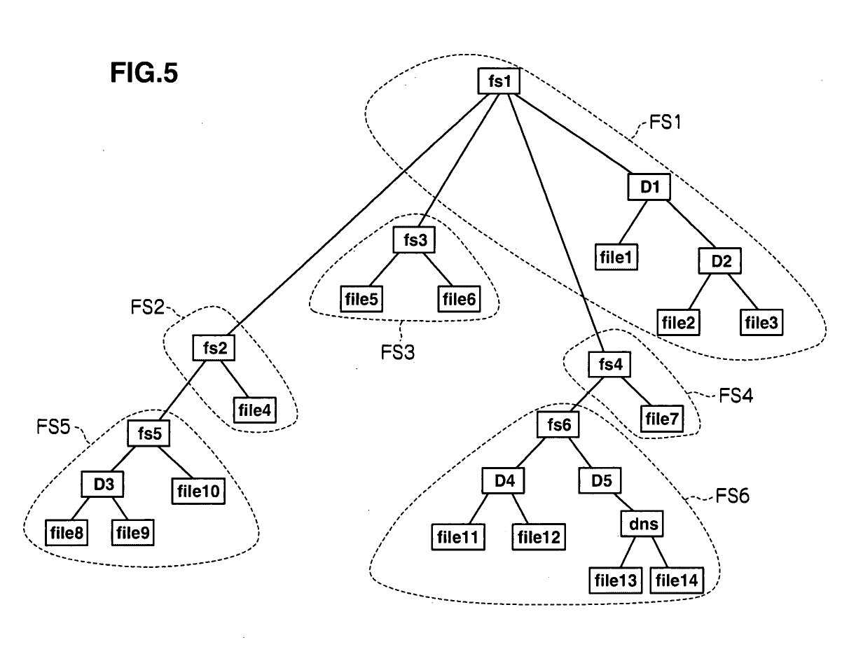

FIG. 5 shows a configuration example of a file tree in the global namespace.

The file tree structure in the global namespace is configured by a plurality of directory groups forming a tree-shaped layered system.

A directory group is an aggregate of directories or an aggregate of data in which the access type is predetermined for a plurality of users using the host system 2. The aggregate of directories or the aggregate of data are of a so-called tree structure configured in layers.

A directory group is able to set a user and the access authority to such user with the directory group as a single unit. For example, when directory groups FS1 to FS6 are formed in the global namespace as shown in FIG. 5, the setting may be that a certain user is able to write in the directory group FS1 and directory group FS2, but is only able to read from the directory groups FS3 to FS6. Further, for another user, the setting may be that such user is able to write in the directory group FS3 and directory group FS4, only read from the directory group FS1, directory group FS2 and directory group FS5, and not allowed to access the directory group FS6. Since the directory groups can be set as described above, it is possible to improve the security (in particular the access authority to files) of users.

In the example of FIG. 5, with the respective directory groups FS1 to FS6, one or more directories or files form a tree structure in each layer with the mount points fs1 to fs6 as the apexes. Specifically, directories D1, D2 exist in a lower layer of the mount point fs1 of the directory group FS1, and single files file 1 to file 3 exist in the lower layer of the directories D1, D2.

### (3) Directory Group Migration Function

Next, the directory group migration function loaded in the storage system of this embodiment is explained.

When a new slave NAS apparatus 4C (FIG. 1) is added on, the storage system 1 optimally reallocates the directory groups that were managed by the master NAS apparatus 4A and the existing slave NAS apparatus 4B to the master NAS apparatus 4A and the respective slave NAS apparatuses 4B, 4C based on the importance of the respective directory groups and the apparatus quality of the respective NAS apparatuses (master NAS apparatus 4A, existing slave NAS apparatus 4B and newly added slave NAS apparatus 4C).

The disk apparatus 43A of the master NAS apparatus 4A stores a directory group affiliated apparatus management table 434A, a global namespace configuration tree management DB 430A, a NAS apparatus quality list management table 432A, a directory group-disk mapping list management table 435A, a directory group configuration list management table 433A, a directory configuration management table 431A, and a setting management table 436A.

### (3-1) Directory Configuration Management Table

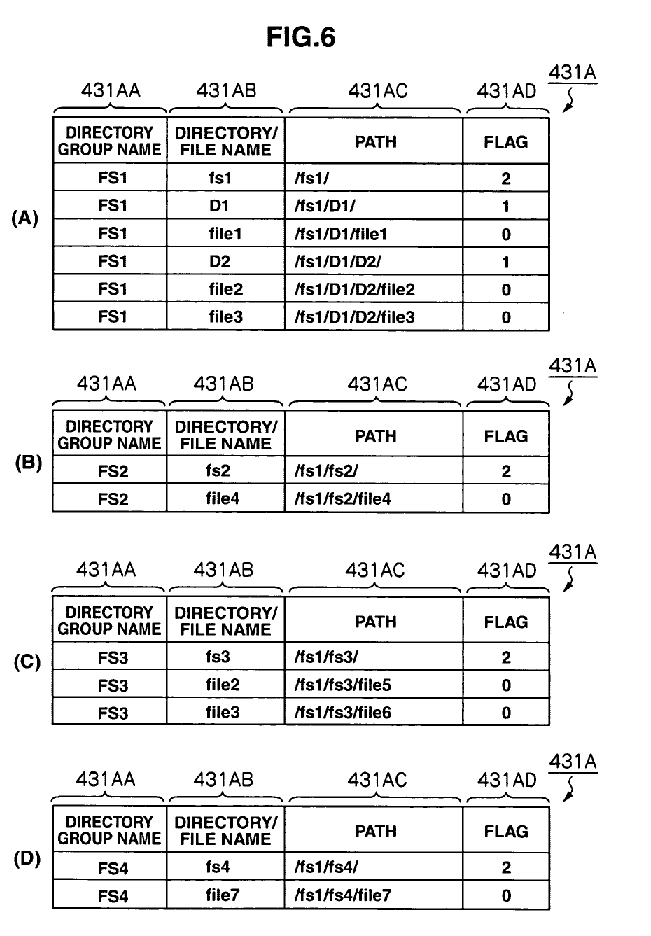

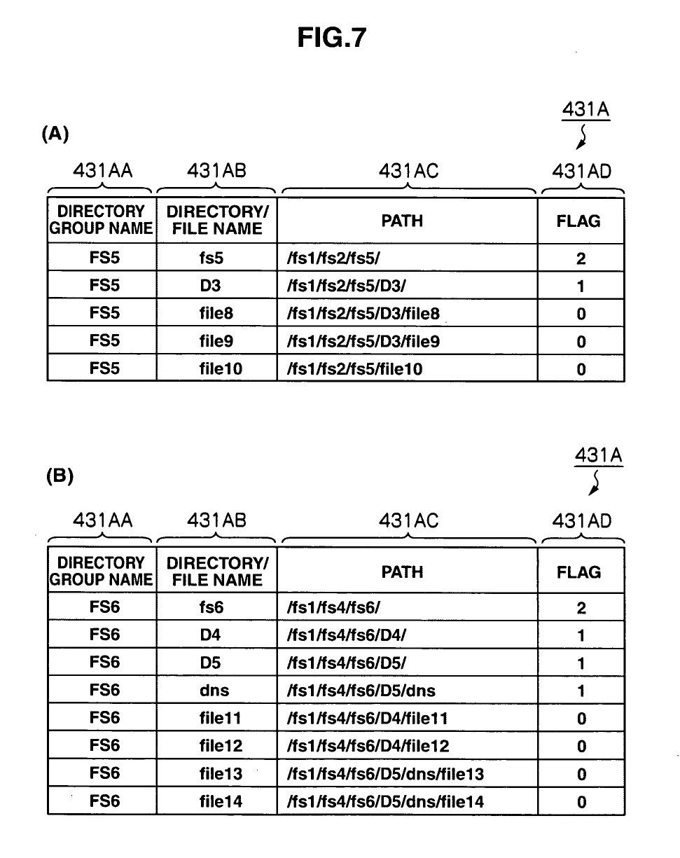

The directory configuration management table 431A is a table for managing the directory configuration of the respective directory groups FS1 to FS6, and, as shown in FIG. 6 and FIG. 7, is provided in correspondence with the respective directory groups FS1 to FS6 existing in the global namespace defined in the storage system 1.

Each directory configuration management table 431A includes a “directory group name” 431M, a “directory/file name” field 431AB, a “path” field 431AC, and a “flag” field 431 AD.

The “directory group name” 431M stores the name of directory groups. The “directory/file name” field 431AB stores the name of directories and files. The “path” field 431AC stores the path name for accessing the directory/file. Further, the “flag” field 431AD stores information representing whether the directory or file corresponding to the entry is a mount point or a directory or a file. In this embodiment, “2” is stored in the “flag” field 431AD when the directory or file corresponding to the entry is a “mount point”, “1” is stored when it is a “directory”, and “0” is stored when it is a “file”.

Accordingly, in the example of FIG. 6A, by pursuing the path of “/fs1”, it is possible to access the mount point of the directory group FS1 corresponding to the directory name of “fs1”. Further, in the example of FIG. 6A, a directory having a name of “D1” exists in the lower layer of the mount point, a file having a name of “file 1” and a directory having a name of “D2” exist in the lower layer, and files having a file name of “file 2” or “file 3” respectively exist in the lower layer.

### (3-2) NAS Apparatus Quality Management Table

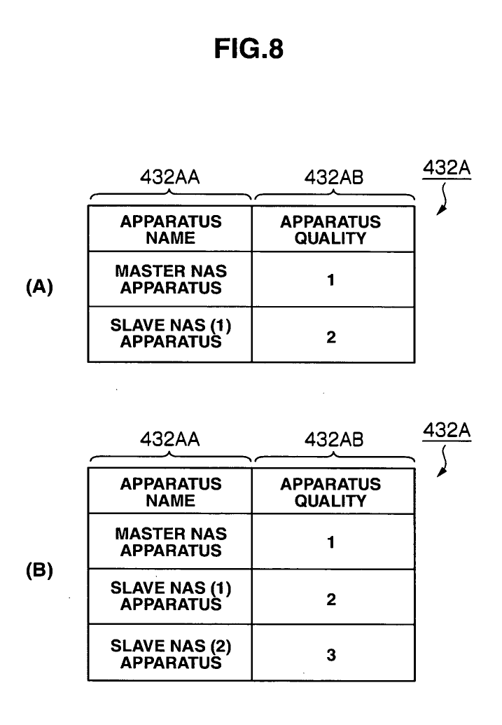

FIG. 8 shows a specific configuration of the NAS apparatus quality management table 432A. The NAS apparatus quality management table 432A is a table for managing the quality of the respective NAS apparatuses (FIG. 8 shows a state before the slave NAS apparatus 4C is added on) existing in the global namespace defined in the storage system 1, and is configured from a “apparatus name” field 432M and a “apparatus quality” field 432AB.

Among the above, the “apparatus name” field 432M stores the name of each of the target NAS apparatuses (master NAS apparatus 4A and slave NAS apparatus 4B), and the “apparatus quality” field 432AB stores the priority of the apparatus quality of these NAS apparatuses. In this embodiment, the apparatus quality is represents by “higher the priority, higher the quality”.

For example, in the example of FIG. 8A, the master NAS apparatus 4A has a higher apparatus quality than the slave NAS apparatus 4B.

Incidentally, when a slave NAS apparatus 4C is newly added, as shown in FIG. 8B, the entry corresponding to the slave NAS apparatus is additionally registered in the NAS apparatus quality management table 432A.

### (3-3) Directory Group Configuration List Management Table

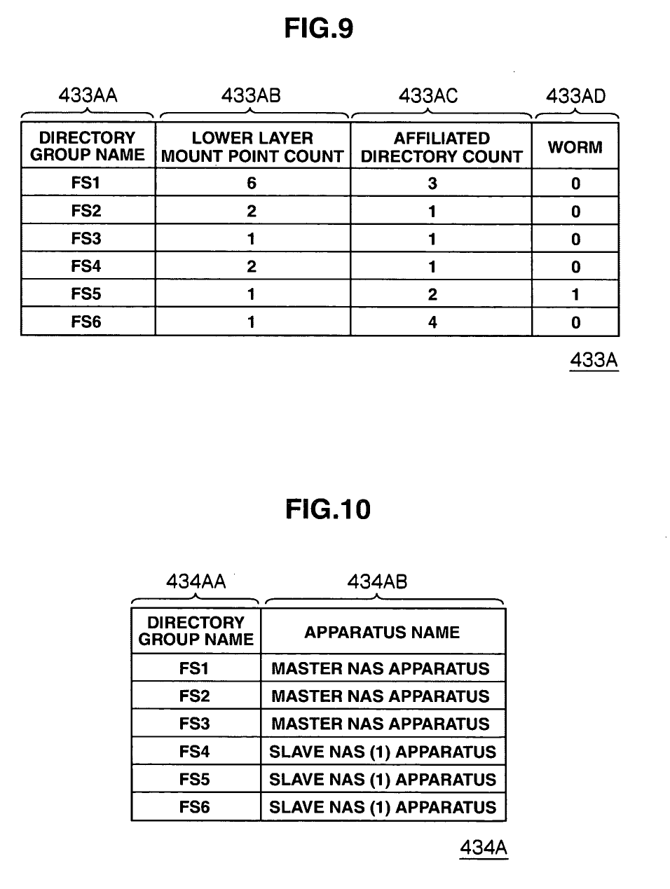

The directory group configuration list management table 433A is a table for managing the configuration of the respective directory groups FS1 to FS6, and, as shown in FIG. 9, is configured from a “directory group name” field 433M, a “lower layer mount point count” field 433AB, an “affiliated directory count” field 433AC, and a “WORM” field 433AD. Among the above, the “directory group name” field 433M stores the name of the directory groups corresponding to the entry. Further, the “lower layer mount point count” field 433AB stores the total number of mount points of the lower layer directory group including the mount points of such directory group. Moreover, the “affiliated directory count” field 433AC stores the total number of directories of such directory group.

The “WORM” field 433AD stores information representing whether a WORM attribute is set in the directory group. Incidentally, a WORM (Write Once Read Many) attribute is an attribute for inhibiting the update/deletion or the like in order to prevent the falsification of data in the directory group. In this embodiment, “0” is stored in the “WORM” field 433AD when the WORM attribute is not set in the directory group, and “1” is set when such WORM attribute is set in the directory group.

Accordingly, in the example of FIG. 9, with respect to the directory group of “FS1”, the “lower layer mount point count” is “6” and the “affiliated directory count” is “3”, and the WORM attribute is not set. Contrarily, with respect to the directory group of “FS5”, the “lower layer mount point count” is “1” and the “affiliated directory count” is “2”, and the WORM attribute is set.

### (3-4) Directory Group Affiliated Management Table

The directory group affiliated management table 434A is a table for managing which NAS apparatus is managing the respective directory groups FS1 to FS6, and, as shown in FIG. 10, is configured from a “directory group name” field 434AA, and a “apparatus name” field 434AB.

Among the above, the “directory group name” field 434M stores the name of the directory groups FS1 to FS6, and the “apparatus name” field 434AB stores the name of the NAS apparatus managing the directory groups FS1 to FS6. Incidentally, FIG. 10 shows the state before the slave NAS apparatus 4C is added on.

For instance, in the example of FIG. 10, the directory group of “FS1” is managed by the master NAS apparatus 4A, and the directory group of “FS5” is managed by the slave NAS apparatus 4B.

### (3-5) Directory Group-Disk Mapping List Management Table

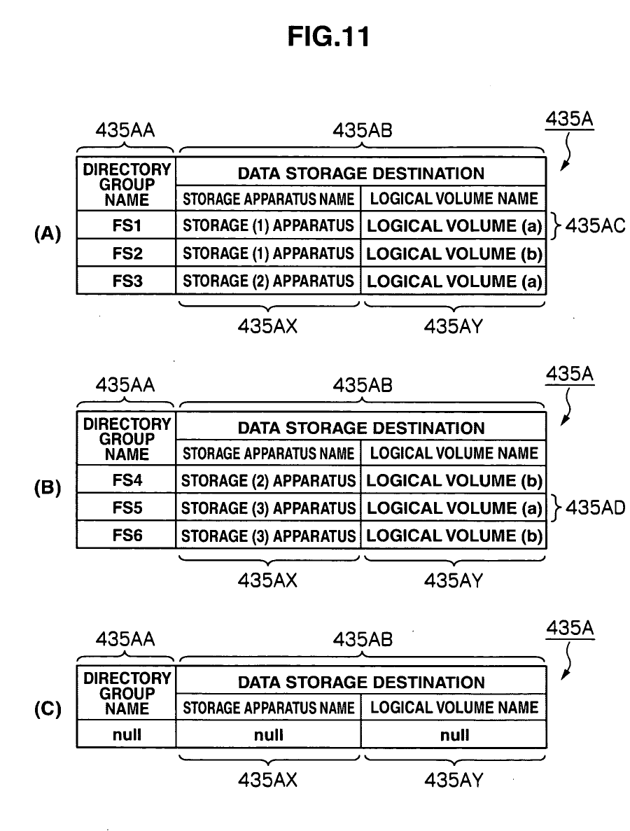

FIG. 11 shows a configuration of the directory group-disk mapping list management table 435A. The directory group-disk mapping list management table 435A is a table for managing which NAS apparatus in the table of FIG. 10 is managing the directory groups FS1 to FS6, and which logical volume of which storage apparatus is storing data, and is configured from a “directory group name” field 435M, and a “data storage destination” field 435AB. Among the above, the “data storage destination” field 435AB is configured from a “storage apparatus name” field 435AX and a “logical volume name” field 435AY.

The “directory group name” field 435M stores the name of the directory groups corresponding to the entry. The “data storage destination” field 435AB stores storage destination information of data in the directory groups. Among the above, the “storage apparatus name” field 435AX stores the name of the storage apparatus storing data in the directory group, and the “logical volume name” field 435AY stores the name of the logical volume in the storage apparatus storing data in the directory group.

For instance, in the example of FIG. 11A, the data storage destination of the directory group “FS1” is the “logical volume VOL (a)” of the “storage (1) apparatus”. Further, FIG. 10 shows that the “master NAS apparatus” is managing the directory group “FS1”.

Similarly, in the example of FIG. 11B, the data storage destination of the directory group “FS5” is the “logical volume VOL (a)” of the “storage (3) apparatus”. Further, FIG. 10 shows that the “slave NAS (1) apparatus” is managing the directory group “FS5”.

This information is managed by the master NAS apparatus 4A as mapping information 435AC, 435AD of the respective directory groups FS1 to FS6.

Incidentally, FIG. 11C shows a configuration of the directory group-disk mapping list management table 435A in the case of adding a directory group. In this case, since the “directory group name” field 435AA, and the “storage apparatus name” field 435AX and “logical volume name” 435AY of the “data storage destination” field 435AB are empty with no information stored therein, “null” representing an empty state is displayed in the respective fields.

### (3-6) Setting Management Table

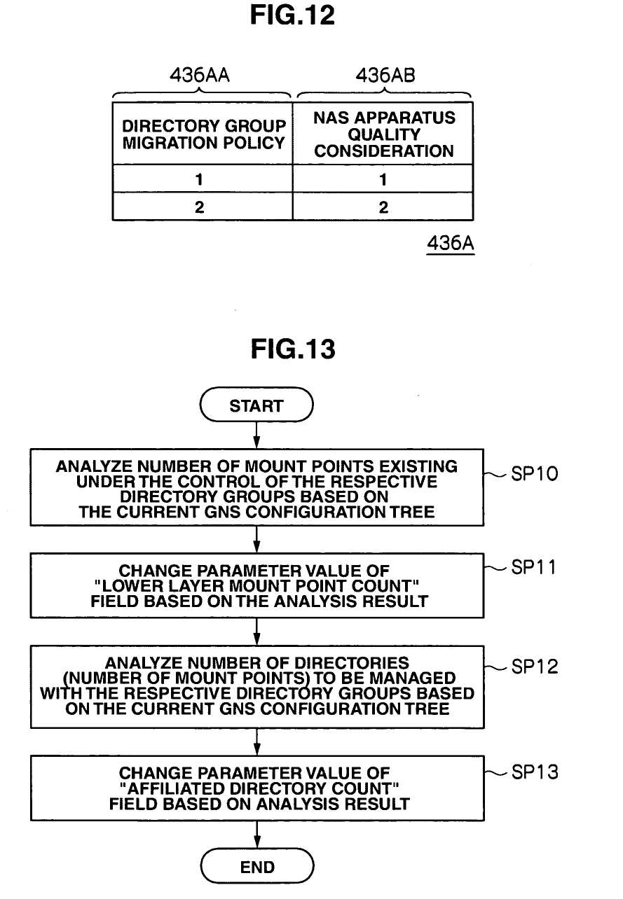

FIG. 12 shows the setting management table 436A in the case of adding a NAS apparatus. The setting management table 436A is a table for managing whether the importance of the directory group and quality of the NAS apparatus are to be preferentially migrated upon migrating the storage destination management information of the directory group to the added NAS apparatus, and is configured from a “directory group migration policy” field 436M, and a “NAS apparatus quality consideration” field 436AB.

The “directory group migration policy” field 436AA stores information enabling the system administrator to set whether the importance of the directory group is to be given preference, or the directory count is to be given preference. When the system administrator sets “1” in the “directory group migration policy” field 436AA, importance of the directory group is given preference, and, when “2” is set, the directory count is given preference.

Here, importance of the directory group is decided based on the total number of lower layer mount points in the directory group, including the mount points of one's own directory group. A directory group having more lower layer mount points is of great importance, and a directory group having few lower layer mount points is of a low importance.

The “NAS apparatus quality consideration” field 436AB stores information enabling the system administrator to set whether to consider the quality of the NAS apparatus. When the system administrator sets “1” in the “NAS apparatus quality consideration” field 436AB, the quality is considered, and when “2” is set, the quality is not considered.

Incidentally, each of the foregoing management tables is updated as needed when a directory group is added, and reflected in the respective management tables.

### (4) Processing Contents of CPU of Master NAS Apparatus relating to Directory Group Migration Function

### (4-1) Directory Group Configuration List Change Processing

Next, the processing contents of the CPU 40A of the master NAS apparatus 4A relating to the directory group migration function are explained. Foremost, the processing routine of the CPU 40A of the master NAS apparatus 4A upon creating a new directory group is explained.

FIG. 13 is a flowchart showing the processing contents of the CPU 40A of the master NAS apparatus 4A relating to the processing of creating a new directory group. The CPU 40A executes the directory group configuration list change processing based on the directory group configuration list change control program 420A stored in the memory 42A of the master NAS apparatus 4A in order to create a new directory group.

In other words, the CPU 40A starts the directory group configuration list change processing periodically or when there is any change in the directory group tree structure in the global namespace, and foremost detects the mount point count of the respective directory groups FS1 to FS6 based on the directory group tree structure in the current global namespace (SP10).

As the detection method to be used in the foregoing case, the CPU 40A employs a method of extracting only the entry in the “directory/file name” field 431AB in which a “flag” is managed as “2” from the “flag” field 431AD of the directory configuration management table 431A configured based on the directory group stored in the global namespace configuration tree management DB 430A.

For example, when the CPU 40A is to detect the lower layer mount point count of the directory group FS1, it extracts the entry in which the “flag” is managed as “2” from the “flag” field 431AD of all directory configuration list management tables 431A. According to FIG. 6 and FIG. 7, the entry of the “directory/file name” field 431AB in which the “flag” is managed as “2” is “fs1” to “fs6”.

Next, the CPU 40A analyzes the name and number of the directory groups existing in the lower layer of the directory group FS1 from the “path” of the “path” field 431 AC of the directory configuration list management table 431A. For example, when the “directory/file name” of the “directory/file name” field 431AB is “fs2”, the path is “/fs1/fs2”, and it is possible to recognize that the directory group FS2 is at the lower layer of the directory group FS1. Similarly, when the “directory/file name” of the “directory/file name” field 431AB is “fs5”, the path “/fs1/fs2/fs5”, and it is possible to recognize that the directory group FS5 is at the lower layer of the directory groups FS1 and FS2.

As a result of the foregoing detection, it is possible to confirm that the mount points fs2 to fs6 are “5” at the lower layer of the directory group FS1. A number obtained by adding “1”, which is the number of mount points of the directory group FS1, to the foregoing “5” is shown in the “lower layer mount point count” field 433AB of the directory group configuration list management table 433A. In other words, the parameter value of the “lower layer mount point count” field 433AB of the directory group configuration list management table 433A will be “6”.

The CPU 40A sequentially detects the mount point count of the directory groups FS2 to FS6 with the same detection method.

Next, the CPU 40A changes the parameter value of the “lower layer mount point count” field 433AB of the directory group configuration list management table 433A based on this detection result (SP11).

Next, the CPU 40A detects the directory count including the mount points fs1 to fs6 of the respective directory groups FS1 to FS6 from the directory configuration management table 431A based on the directory group tree structure in the current global namespace (SP12).

As the detection method to be used in the foregoing case, the CPU 40A employs a method of extracting those in which the respective “flags” of the directory configuration management table 431A are managed as “2” and “1” based on the global namespace configuration tree management DB 430A.

For example, when the CPU 40A is to detect the directory count of the directory group FS1, it foremost extracts the table in which the “flag” is managed as “2” or “1” from the “flag” field 431AC of all directory configuration list management tables 431A. According to FIG. 6A, “fs1” is the one in which the “flag” is managed as “2”. Further, “D1” and “D2” are the ones in which the “flag” is managed as “1”.

As a result of the foregoing processing, it is possible to recognize that the total number of directories of the directory group FS1 is “3” including the mount point fs1. In other words, the parameter value of the “affiliated directory count” field 433AC of the directory group configuration management table 433A will be “3”.

The CPU 40A also sequentially detects the directory count of the directory groups FS2 to FS6 with the same detection method.

The CPU 40A thereafter changes the parameter value of the “affiliated directory count” field 433AC of the directory group configuration list management table 433A based on this detection result (SP13), and thereafter ends this sequential directory group configuration list change processing.

### (4-2) NAS Apparatus Setting Change Processing

### (4-2-1) Management Information Registration Screen

Next, the processing routine of the CPU 40A of the master NAS apparatus 4A for setting the change of management information of the existing slave NAS apparatus 4B or setting management information upon newly adding a slave NAS apparatus 4C is explained.

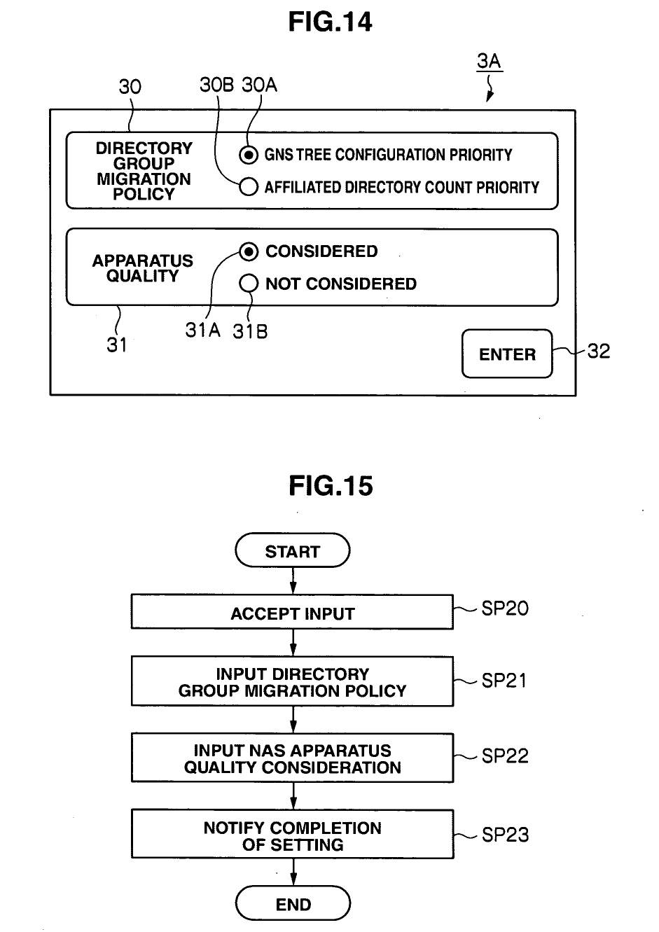

The system administrator operates the management terminal apparatus 3 to register the change of management information of the existing slave NAS apparatus 4B shown in FIG. 14, or display a registration screen (this is hereinafter referred to as a “management information registration screen”) 3A for registering the setting of management information of the newly added slave NAS apparatus 4C on the display of the management terminal apparatus 3.

The management information registration screen 3A is provided with a directory group migration policy setting column 30 for setting the policy of the system administrator concerning the migration of directory groups, a apparatus quality setting column 31 for setting whether to give consideration to the apparatus quality of the respective NAS apparatuses upon migrating the directory group, and an “enter” button 32.

As the policy upon deciding the NAS apparatus to become the migration destination of the directory group, the directory group migration policy setting column 30 is provided with two radio buttons 30A, 30B respectively corresponding to a policy of giving preference to the importance of the directory group (this is hereinafter referred to as a “first directory group migration policy”), and a policy of giving preference to the directory count in the directory group affiliated to the respective NAS apparatuses (this is hereinafter referred to as a “second directory group migration policy”). As a result, the system administrator is able to set a policy associated with the radio button as the directory group migration policy by clicking the radio button corresponding to one's desired policy among the first and second directory group migration policies.

Further, the apparatus quality setting column 31 is provided with two radio buttons 31A, 31 B respectively corresponding to an option of giving consideration to the apparatus quality of the NAS apparatus upon deciding the NAS apparatus to become the migration destination of the directory group (this is hereinafter referred to as a “first apparatus quality option”) and an option of not giving consideration to the apparatus quality of the NAS apparatus (this is hereinafter referred to as a “second apparatus quality option”). As a result, the system administrator is able to set whether to give consideration to the apparatus quality of the NAS apparatus upon deciding the migration destination NAS apparatus of the directory group by clicking the radio button 31A, 31B corresponding to one's desired option among the first and second apparatus quality options.

The enter button 32 is a button for making the master NAS apparatus 4A recognize the setting of the directory group migration policy and apparatus quality. The system administrator is able to make the master NAS apparatus 4A recognize the set information by clicking the “enter” button 32 after selecting the desired directory group migration policy and apparatus quality.

Incidentally, upon deciding the migration destination NAS apparatus of the directory group, since the quality of the NAS apparatus 4A to 4C will naturally be considered when giving preference to the importance of the directory groups FS1 to FS6, in the case of this embodiment according to the present invention, two types of selections can be made as illustrated in FIG. 12.

### (4-2-2) Setting Change Processing Routine

FIG. 15 is a flowchart showing the processing contents of the CPU 40A of the master NAS apparatus 4A when setting the change of management information of the existing slave NAS apparatus 4B or setting management information upon newly adding a slave NAS apparatus 4C. The CPU 40A executes the setting change processing based on the setting change control program 422A stored in the memory 42A of the master NAS apparatus 4A in order to set the change of management information of the existing slave NAS apparatus 4B or set the management information of the newly added slave NAS apparatus 4C.

In other words, when the “enter” button 32 of the management information registration screen 3A described with reference to FIG. 14 is clicked, the management terminal apparatus 3 sends registration information regarding the migration policy and apparatus quality of the respective slave NAS apparatuses 4B, 4C to the master NAS apparatus 4A.

When the CPU 40A of the master NAS apparatus 4A receives the registration information, it starts the setting change processing illustrated in FIG. 15, and foremost accepts the registration information (SP20). When the system administrator thereafter inputs registration information regarding the directory group migration policy of the master NAS apparatus 4A and the respective slave NAS apparatuses 4B, 4C (SP21), the CPU 40A stores the registration information concerning the directory group migration policy in the setting management table 436A.

Next, when the system administrator inputs the registration information relating to the quality consideration of the NAS apparatus (SP22), the CPU 40A stores the registration information concerning the quality consideration in the NAS apparatus quality list management table 432A, and thereafter notifies the management terminal apparatus 3 to the effect that the change setting processing or setting processing is complete (SP23). The CPU 40A thereafter ends this setting change processing routine.

### (4-3) Initialization Processing of Expanded NAS Apparatus

### (4-3-1) Expanded NAS Registration Screen Next, the routine of registering the slave NAS apparatus 3C as a NAS apparatus in the global namespace defined in the storage system 1 upon newly adding a slave NAS apparatus 4C is explained.

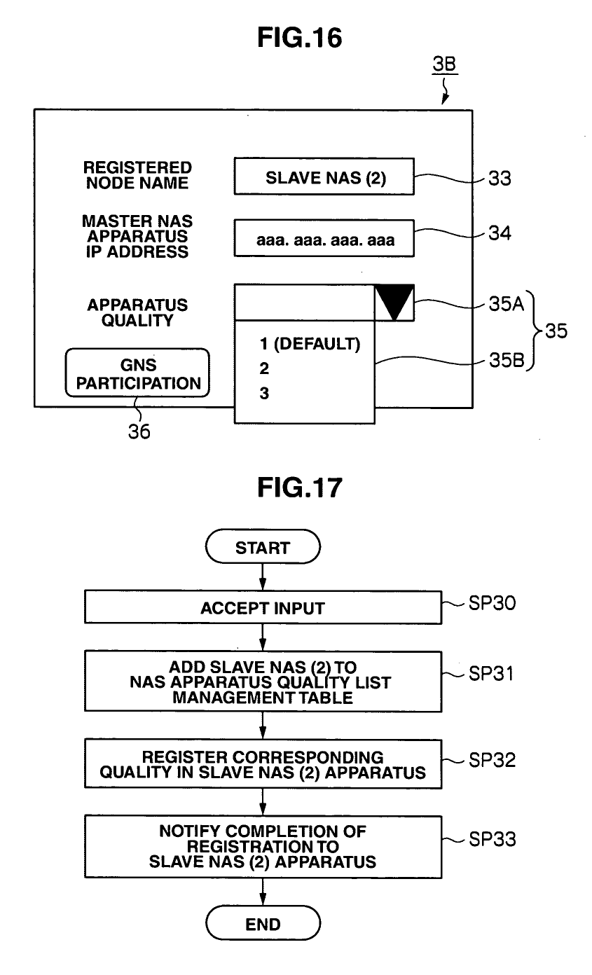

The system administrator may operate the management terminal apparatus 3 to display the expanded NAS registration screen 3B illustrated in FIG. 16 on the display of the management terminal apparatus 3.

The expanded NAS registration screen 3B is provided with a “registered node name” entry box 33 for inputting the name of the NAS apparatus to be added, a “master NAS apparatus IP address” entry box 34 for inputting the master NAS apparatus IP address, a “apparatus quality” display box 35 for designating the quality of the slave NAS apparatus 4C, and a “GNS participation” button 36.

With the expanded NAS registration screen 3B, a keyboard or the like may be used to respectively input the registered node name of the NAS apparatus to be added (“slave NAS (2)” in the example shown in FIG. 16) and the IP address of the master NAS apparatus (“aaa.aaa.aaa.aaa” in the example shown in FIG. 16) in the “registered node name” entry box 33 and the “master NAS apparatus IP address” input box 34.

Further, with the expanded NAS registration screen 3B, a menu button 35A is provided on the right side of the “apparatus quality” display box 35, and, by clicking the menu button 35A, as shown in FIG. 16, it is possible to display a pulldown menu 35B listing one or more apparatus qualities (“1” to “3” in the example shown in FIG. 16) that can be set in the NAS apparatus to be added. Then, the system administrator is able to select the desired apparatus quality from the apparatus qualities displayed on the pulldown menu 35B. The apparatus quality selected here is displayed in the “apparatus quality” display box 35.

The “GNS participation” button 36 is a button for registering the NAS apparatus to be added under the global namespace control of the master NAS apparatus 4A. By the system administrator inputting in a prescribed input box 33, 34, selecting a desired apparatus quality, and thereafter clicking the “GNS participation” button 36, it is possible to set the NAS apparatus to be added under the control of the master NAS apparatus 4A designated by the system administrator.

### (4-3-2) NAS Apparatus Quality List Change Processing

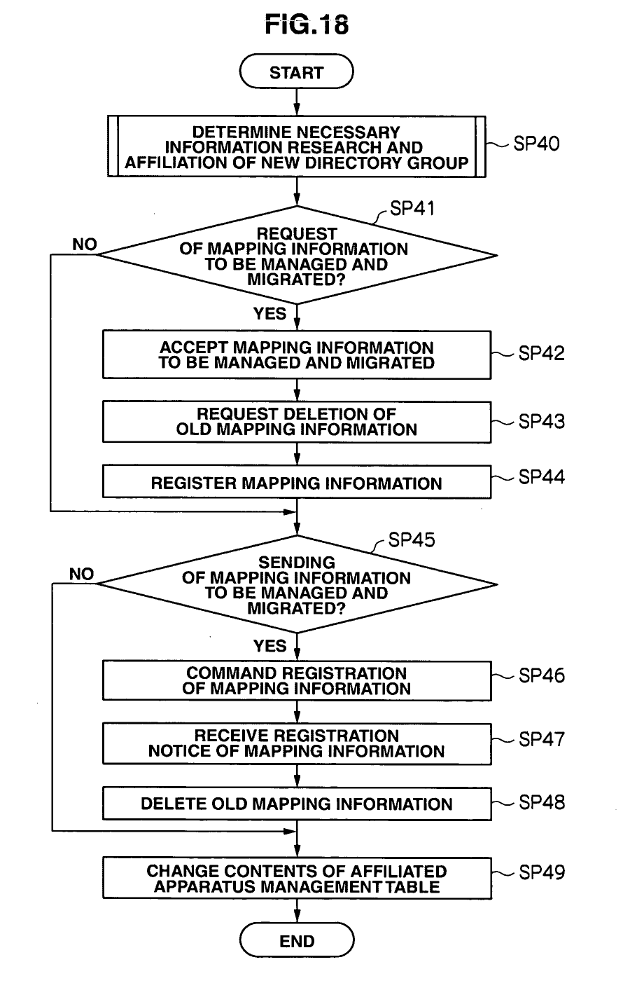

Next, the processing contents of the CPU 40A of the master NAS apparatus 4A relating to the NAS apparatus quality management is explained. In connection with this, FIG. 17 is a flowchart representing the sequential processing routine upon changing the NAS apparatus quality list management table 432A based on the setting of the system administrator in the expanded NAS registration screen 3B. The CPU 40A of the master NAS apparatus 4A executes the NAS apparatus quality list change processing according to the routine illustrated in FIG. 17 based on the NAS apparatus quality list change control program 421A stored in the memory 42A.

In other words, when the “GNS participation” button 36 of the expanded NAS registration screen 3B is clicked, the management terminal apparatus 3 sends the registration information (registered node name, IP address and apparatus quality of the master NAS apparatus) regarding the slave NAS apparatus 4C input using the expanded NAS registration screen 3B to the master NAS apparatus 4A.

When the CPU 40A of the master NAS apparatus 4A receives the registration information, it starts the NAS apparatus quality list change processing shown in FIG. 17, and foremost accepts the registration information (SP30), and thereafter adds the entry of the slave NAS apparatus 4C to the NAS apparatus quality list management table 432A based on the registration information of the slave NAS apparatus 4C (SP31).

Next, the CPU 40A registers the quality corresponding to the slave NAS apparatus 4C in the NAS apparatus quality list management table 432A (SP32), and thereafter notifies the slave NAS apparatus 4C to the effect that the registration processing of the slave NAS apparatus 4C is complete (SP33). The CPU 40A thereafter ends the NAS apparatus quality list change processing routine.

The sequential processing routine for migrating the management information of the directory group after the slave NAS apparatus 4C is initialized as described above is now explained.

### (4-4) Configuration Information Migration Processing

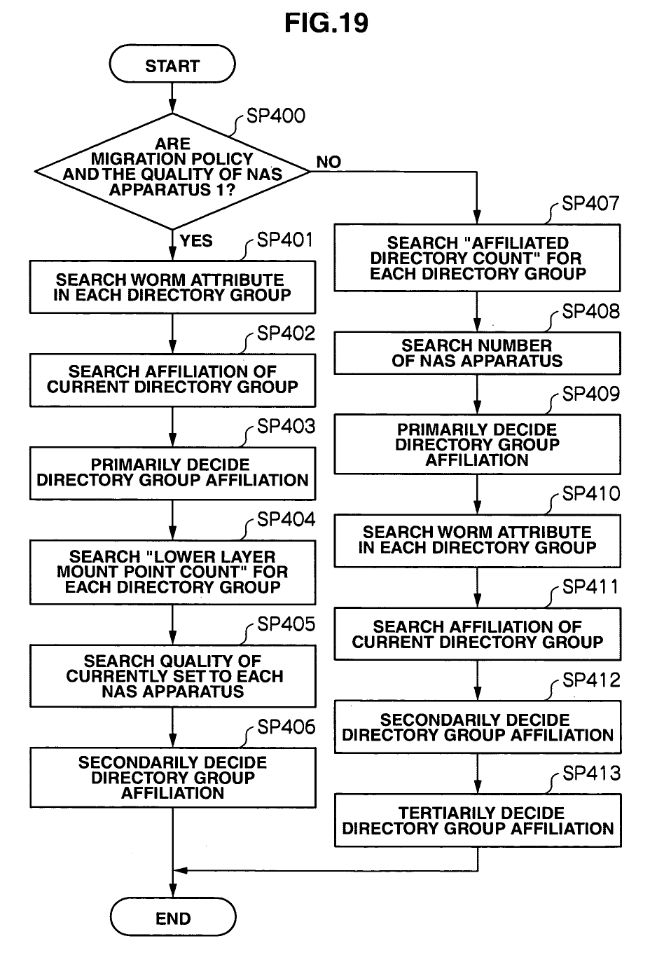

The processing contents of the CPU 40A of the master NAS apparatus 4A for migrating the storage destination management information of the directory group to the plurality of NAS apparatuses 4A to 4C including the slave NAS apparatus 4C to be added is now explained. In connection with this, the CPU 40A executes the configuration information migration processing according to the routine illustrated in FIG. 18 and FIG. 19 based on the configuration information migration control program 423A stored in the memory 42A.

In other words, the CPU 40A starts the configuration information migration processing periodically or when a new NAS apparatus 4C is added, and foremost determines the information research required in the directory groups FS1 to FS6 and the affiliation of the new directory group (SP40). The specific processing for this determination will be described later with reference to the flowchart illustrated in FIG. 19.

Next, the CPU 40A determines whether to make an import request of mapping information from the existing slave NAS apparatus 4B or the added slave NAS apparatus 4C registered with the mapping information of the directory group to be managed and migrated (SP41). Here, mapping information refers to the information associating the directory group information to be managed and migrated and the location where the data corresponding to the directory group is stored as illustrated in FIG. 11 (435AC and 435AD of FIG. 11).

When importing the mapping information, the CPU 40A makes an import request of mapping information to the existing slave NAS apparatus 4B or the added slave NAS apparatus 4C. The respective slave NAS apparatuses 4B, 4C that received the request for importing mapping information sends the mapping information to be managed and migrated to the master NAS apparatus 4A, and the CPU 40A receives the mapping information (SP42). When the CPU 40A receives the mapping information, it requests the deletion of the mapping information sent from the existing slave NAS apparatus 4B or added slave NAS apparatus 4C (SP43), and registers the received mapping information in the directory group-disk mapping list management table 435A (SP44). Like this, management information of the directory group is migrated from the existing slave NAS apparatus 4B or the added slave NAS apparatus 4C to the master NAS apparatus 4A.

Meanwhile, when an import request of mapping information is not made, the CPU 40A proceeds to the subsequent processing routine.

In other words, the CPU 40A determines whether to send the mapping information from one's own apparatus (master NAS apparatus 4A) registering the mapping information of the directory group to be managed and migrated to the existing slave NAS apparatus 4B or the added slave NAS apparatus 4C (SP45).

When sending the mapping information, the CPU 40A commands the existing slave NAS apparatus 4B or the added slave NAS apparatus 4C to register the mapping information to be managed and migrated (SP46). When the existing slave NAS apparatus 4B or the added slave NAS apparatus 4C receives the completion notice of registering the mapping information (SP47), the CPU 40A deletes the mapping information to be managed and migrated from the directory group-disk mapping list management table 435A (SP48). Like this, the master NAS apparatus 4A migrates the management information of the directory group to the existing slave NAS apparatus 4B or the added slave NAS apparatus 4C.

When the mapping information is not sent, the CPU 40A proceeds to the subsequent processing routine.

When the CPU 40A receives the mapping information migrated from the existing slave NAS apparatus 4B or the added slave NAS apparatus 4C, or when migrating the mapping information to the existing slave NAS apparatus 4B or the added slave NAS apparatus 4C, it starts the change processing routine of the directory group affiliated apparatus management table 434A.

When the mapping information of the directory group-disk mapping list management table 435A of the master NAS apparatus 4A is added or deleted, the CPU 40A changes the storage destination management information of the directory group affiliated apparatus management table 434A (SP49).

The CPU 40A of the master NAS apparatus 4A thereby ends the change processing of the directory group affiliated apparatus management table 434A.

Next, the specific processing routine for determining the information research required in the directory group FS1 to FS6 and affiliation of the new directory group is explained with reference to FIG. 19.

Foremost, the CPU 40A of the master NAS apparatus 4A determines whether the “directory group migration policy” and “apparatus quality” of the CPU 40A are both “1” (SP400). This is determined by the CPU 40A executing the NAS apparatus quality change processing and setting change processing based on the NAS apparatus quality list change control program 421A and the setting change control program 422A.

### (4-4-1) Processing of Giving Preference to Importance of Directory Group

When the CPU 40A determines the above to be “1”, the migration routine is performed by giving preference to the importance of the directory groups FS1 to FS6 based on the mount point count and the quality of the apparatus.

Foremost, the CPU 40A checks the WORM attribute of the respective directory groups FS1 to FS6 from the directory group configuration list management table 433A (SP401). For example, according to FIG. 9, it is possible to confirm that the directory group FS5 is “1”, and that the other directory groups FS1 to FS4, FS6 are “0”.

Since the directory group FS5 has a WORM flag, the CPU 40A of the master NAS apparatus 4A checks the affiliated apparatus to which the directory group FS5 is currently affiliated from the directory group affiliated apparatus management table 434A (SP402). According the example, the CPU 40A confirms that the affiliated apparatus of the directory group FS5 is the existing slave NAS apparatus 4B, and determines that the storage destination management information of the directory group FS5 should not be migrated.

As a result, the CPU 40A primarily decides the respective directory group affiliations (SP403). According to the example, the affiliations of [FS1-master NAS], [FS2, FS4, FS5-slave NAS (1)], and [FS3, FS6-slave NAS (2)] are primarily decided.

Next, the CPU 40A checks the “lower layer mount point count” from the directory group configuration list management table 433A (SP404). According to the example, the CPU 40A confirms [FS1-6], [FS2-2], [FS3-1], [FS4-2], [FS5-1], and [FS6-1]. As a result, it is possible to determine that the directory group having the highest lower layer mount point count is of the greatest importance, and FS1 has the greatest importance, sequentially followed by FS2 and FS4, and FS3, FS5 and FS6 in the order of importance.

Next, the CPU 40A checks the respective NAS apparatus (here, the master NAS apparatus 4A and respective slave NAS apparatuses 4B, 4C) that are current registered and the quality set in the respective NAS apparatus from the NAS apparatus quality management table 432A (SP405). It is possible to confirm [master NAS-1], [slave NAS (1)-2], and [slave NAS (2)-3]. As a result, it is possible to determine that the master NAS apparatus 4A is the NAS apparatus with the highest quality.

Therefore, if the CPU 40A determines to associate a NAS apparatus with high importance and high quality, it will decide on [master NAS-FS1], [slave NAS (1)-FS2, FS4], and [slave NAS (2)-FS3, FS5, FS6]. Nevertheless, since it has been primarily decided that the directory group FS5 has a WORM flag, the CPU 40A determines that the storage destination management information should not be migrated to the slave NAS (2) apparatus, and secondarily decides the affiliation of the directory group (SP406). In other words, it will decide on [master NAS-FS1], [slave NAS (1)-FS2, FS4, FS5], and [slave NAS (2)-FS3, FS6].

After making the foregoing decision, the CPU 40A ends the processing of giving preference to the importance of the directory group.

### (4-4-2) Processing Giving Consideration to Load of NAS Apparatus

When the CPU 40A of the master NAS apparatus 4A determines the above to be “2”, the migration routine based on the even migration of the directory count is performed giving consideration to the load of the respective NAS apparatuses (master NAS apparatus 4A and respective slave NAS apparatuses 4B, 4C).

Foremost, the CPU 40A checks the “directory count” of the respective directory groups from the directory group configuration list management table 433A (SP407). According to the example, it is possible to confirm [FS1-3], [FS2-1], [FS3-1], [FS4-2], [FS5-1], and [FS6-4]. As a result, it is possible to confirm the total number of directories. According to the example, the total number of directories is 12.

Then, the CPU 40A confirms the number of affiliated apparatuses of the respective directory groups from the NAS apparatus quality list management table 432A and checks the number of added NAS apparatuses (here, slave NAS apparatus 4C) (SP408). According to the example, it is possible to confirm that there are two existing NAS apparatuses, one expanded NAS apparatus, which equals a total of three apparatuses.

Only a combination of the directory group and NAS apparatus capable of evenly migrating the directory count according to the total number of directories and the number of NAS apparatuses is primarily decided (SP409). Only a combination means that the migration destination NAS apparatus is not decided. According to the example, only the combination of [FS1, FS2], [FS3, FS4, FS5], and [FS6] is primarily decided.

Next, the CPU 40A checks the WORM attribute in the respective directory groups from the directory group configuration list management table 433A (SP410). For instance, according to FIG. 9, it is possible to confirm that the directory group FS5 is “1”, and the other directory groups FS1 to FS4, FS6 are “0”.

Since the directory group FS5 has a WORM flag, the CPU 40A checks the affiliated apparatus to which the directory group FS5 is currently affiliated from the directory group affiliated apparatus management table 434A (SP411). According to the example, it is possible to confirm the affiliated apparatus of the directory group FS5 is the slave NAS apparatus 4B, and it is determined that the management information of the directory group FS5 should not be migrated.

The primarily decided combination is determined and secondarily decided giving preference to the affiliated apparatus of the directory group with the WORM flag so that the directory group is not migrated (SP412). According to the example, [FS1, FS2-not yet determined], [FS3, FS4, FS5-slave NAS (1)], and [FS6-not yet determined] are secondarily decided.

The CPU 40A tertiarily decides so that the other directory groups other than the secondarily decided directory groups will not be migrated from the currently affiliated NAS apparatus based on the primarily decided combination result decided so that the directory counts are evenly migrated based on the total number of directories and the number of NAS apparatuses (SP413). According to the example, [FS1, FS2-master NAS], [FS3, FS4, FS5-slave NAS (1)], and [FS6-slave NAS (2)] are tertiarily decided. According to this example, the directory count managed by the respective NAS apparatuses will be an allocation of 4.

The CPU 40A thereafter ends the processing giving consideration to the load of the NAS apparatus.

Meanwhile, when the CPU 40A ends the processing giving preference to the importance of the directory group based on the mount point count or the quality of the apparatus, or the processing based on the even migration of the directory count in consideration of the load of the NAS apparatus, it will execute the management migration processing described above.

Incidentally, the following processing routine is performed when migrating the mapping information from the added slave NAS apparatus 4C to the existing slave NAS apparatus 4B.

The CPU 40A of the master NAS apparatus 4A requests a migration command of mapping information to the existing slave NAS apparatus 4B. The existing slave NAS apparatus 4B that received the request requests a migration command of mapping information to the added slave NAS apparatus 4C.

The added slave NAS apparatus 4C that received the request sends the mapping information to the existing slave NAS apparatus 4B.

The same processing routine is performed when migrating the mapping information from the existing slave NAS apparatus 4B to the added slave NAS apparatus 4C.

Like this, with the storage system 1, since the storage destination management information of data is migrated to the NAS apparatus according to the importance of the directory group based on the mount point count or evenness of the directory count, it is possible to abbreviate the management process to be performed by the system administrator of migrating the data group to the respective data management apparatuses when adding a data management apparatus.

### (5) Other Embodiments

Incidentally, in the first embodiment described above, although a case was explained where the CPU in the master NAS apparatus migrates the storage destination management information of data to the respective NAS apparatuses including one's own apparatus according to the importance of the directory group based on the mount point count or even allocation of the directory count, the present invention is not limited thereto, and various other configurations may be broadly applied.

The present invention may be widely applied to storage systems for managing a plurality of directory groups, and storage systems in various other modes.

We claim:

1. A storage system comprising one or more storage apparatuses; and a plurality of data management apparatuses for managing a data group stored in a storage extent provided by said storage apparatuses,
wherein at least one of said data management apparatuses decides the respective data management apparatuses to newly manage said data group for each of said data groups based on the importance of each of said data groups or the loaded condition of each of said data management apparatuses, and migrates storage destination management information containing information regarding the storage destination of said data group to said data management apparatus to newly manage said data group based on said decision as necessary.

2. The storage system according to claim 1,
wherein said data group is a directory group; and
wherein at least one of said data management apparatuses decides the respective data management apparatuses to newly manage said data group for each of said directory groups based on the number of mount points as points for accessing said directory group and/or the number of directories existing in said directory group.

3. The storage system according to claim 2,
wherein said directory group is a tree configuration; and
wherein at least one of said data management apparatuses decides the respective data management apparatuses to newly manage said data group for each of said directory groups so that the importance of directory groups is decided in descending order based on the number of mount points belonging to a lower layer among the mount points, and high-quality data management apparatuses are managed in descending order of importance of said directory group.

4. The storage system according to claim 2,
wherein said directory group is a tree configuration; and
wherein at least one of said data management apparatuses decides the respective data management apparatuses to newly manage said data group for each of said directory groups so that the number of directories is managed evenly in relation to the data management apparatuses based on the number of directories and number of data management apparatuses.

5. The storage system according to claim 2, wherein said directory group in which the data thereof is inhibited from being updated is not migrated to said data management apparatus to newly manage said data group.

6. A data management apparatus for storing a data group stored in a storage extent provided by a storage apparatus, comprising:
a decision unit for deciding the respective data management apparatuses to newly manage said data group for each of said data groups based on the importance of each of said data groups or the loaded condition of each of said data management apparatuses; and
a management information migration unit for migrating storage destination management information containing information regarding the storage destination of said data group to said data management apparatus to newly manage said data group based on said decision as necessary.

7. The data management apparatus according to claim 6,
wherein said data group is a directory group; and
wherein said data management apparatus decides the respective data management apparatuses to newly manage said data group for each of said directory groups based on the number of mount points as points for accessing said directory group and/or the number of directories existing in said directory group.

8. The data management apparatus according to claim 7,
wherein said directory group is a tree configuration; and
wherein said data management apparatus decides the respective data management apparatuses to newly manage said data group for each of said directory groups so that the importance of directory groups is decided in descending order based on the number of mount points belonging to a lower layer among the mount points, and high-quality data management apparatuses are managed in descending order of importance of said directory group.

9. The data management apparatus according to claim 7,
wherein said directory group is a tree configuration; and
wherein said data management apparatus decides the respective data management apparatuses to newly manage said data group for each of said directory groups so that the number of directories is managed evenly in relation to the data management apparatuses based on the number of directories and number of data management apparatuses.

10. The data management apparatus according to claim 7, wherein said directory group in which the data thereof is inhibited from being updated is not migrated to said data management apparatus to newly manage said data group.

11. A data management method in a data management apparatus for storing a data group stored in a storage extent provided by a storage apparatus, comprising the steps of:
deciding the respective data management apparatuses to newly manage said data group for each of said data groups based on the importance of each of said data groups or the loaded condition of each of said data management apparatuses; and
migrating storage destination management information containing information regarding the storage destination of said data group to said data management apparatus to newly manage said data group based on said decision as necessary.

12. The data management method according to claim 11,
wherein said data group is a directory group; and
wherein, at said deciding step, the respective data management apparatuses to newly manage said data group for each of said directory groups based on the number of mount points as points for accessing said directory group and/or the number of directories existing in said directory group are decided.

13. The data management method according to claim 12,
wherein said directory group is a tree configuration; and
wherein, at said deciding step, the respective data management apparatuses to newly manage said data group for each of said directory groups are decided so that the importance of directory groups is decided in descending order based on the number of mount points belonging to a lower layer among the mount points, and high-quality data management apparatuses are managed in descending order of importance of said directory group.

14. The data management method according to claim 12,
wherein said directory group is a tree configuration; and
wherein, at said deciding step, the respective data management apparatuses to newly manage said data group for each of said directory groups are decided so that the number of directories is managed evenly in relation to the data management apparatuses based on the number of directories and number of data management apparatuses.

15. The data management method according to claim 12, wherein said directory group in which the data thereof is inhibited from being updated is not migrated to said data management apparatus to newly manage said data group.
